(19) United States
(12) Patent Application Publication
(10) Pub. No.: US 2023/0280244 A1
(43) Pub. Date: Sep. 7, 2023

(54) APPARATUS AND METHOD FOR PROCESSING AND ANALYSING A MEASUREMENT FLUID FOR MEASUREMENT IN A MEASURING DEVICE

(71) Applicant: USEPAT GMBH, Wien (AT)

(72) Inventors: Stefan RADEL, Wien (AT); Stefan TAUBER, Wien (AT)

(21) Appl. No.: 18/002,515

(22) PCT Filed: Jun. 23, 2021
(86) PCT No.: PCT/AT2021/060220

§ 371 Date: Dec. 20, 2022

(30) Foreign Application Priority Data
Jun. 24, 2020 (AT) A50536/2020

(51) Int. Cl. G01N 1/40

(52) U.S. Cl. CPC G01N 1/4077; G01N 2001/4094

(57) ABSTRACT

The invention relates to an apparatus for processing and analyzing a measurement fluid for measurement in a measurement device, comprising a fluid chamber which is filled by the measurement fluid or through which the measurement fluid flows during operation, an electrically driven ultrasound driver which causes the measurement fluid to vibrate during operation by applying an electrical operating voltage, wherein the measurement fluid, the ultrasound driver, a reflector as applicable and additional layers as applicable are parts of a resonator and of a common mechanical vibration system during operation.

The invention relates to an apparatus, a measuring device and a method according to the preambles of the independent patent claims. In particular, the invention relates to an apparatus and a method for processing and/or analysing a measurement fluid for use in a measuring device. Examples of measuring devices as understood by the invention are measuring devices for fluid analysis, measuring devices for spectroscopy, such as infrared spectrometers, UV spectrometers, absorption spectrometers, emission spectrometers such as Raman spectrometers or also measuring devices of the type of process analysis technology (PAT).

From prior art, devices for processing a measurement fluid comprising a so-called resonator are known. A resonator usually comprises a container for holding the measurement fluid and at least one component for generating a mechanical oscillation in the measurement fluid. For example, a resonator makes it possible to separate or agglomerate particles contained in the measurement fluid by creating a resonance state through which the particles gather at the nodal points of the waves of the resonance. According to the prior art, this resonance state is usually set manually by adjusting the frequency and amplitude of the component to generate the mechanical oscillation. Checking whether an optimal resonance state has been established can often not be done with sufficient accuracy. In addition, the effect that the frequency required for the desired resonance state changes in the course of operation is frequently observed in practice.

Thus, the object of the invention is to provide an apparatus, a measuring device and a method in which an improved analysis of a measurement fluid and an improved adjustability of resonance states are enabled, whereby the analysis and the adjustability are to be carried out in a reliable manner and preferably by simple inexpensive means.

In particular, the object according to the invention is solved by the features of the independent patent claims.

Preferably, the apparatus comprises a fluid chamber, which is filled by the measurement fluid or through which the measurement fluid flows during operation. Additionally, the apparatus comprises an electrically driven ultrasonic driver, which causes the measurement fluid to oscillate during operation by applying an electrical operating voltage. Preferably, the ultrasonic driver comprises several ultrasonic driver units, which may optionally be arranged at different positions along the fluid chamber. During operation, the measurement fluid, the ultrasonic driver, optionally a reflector and optionally other layers form parts of a resonator and a common mechanical oscillation system.

Now it was found that not only the ultrasonic driver has an influence on the oscillation of the measurement fluid, but also that the measurement fluid or its oscillation has an influence on the oscillation behaviour of the ultrasonic driver.

According to the invention, this effect may be used in such a way that conclusions can be drawn about the mechanical oscillation state of the oscillation system by measuring electrical parameters.

In particular, according to the invention, a measuring device is provided which detects the current and/or the voltage and/or the phase shift at the ultrasonic driver in order to determine the oscillation state of the mechanical oscillation system during operation. The measuring device measures the current and/or the voltage and/or the phase shift at the ultrasonic driver—and this during operation—i.e. under operating voltage. In all embodiments, it may optionally be provided that the measuring device for determining the oscillation state of the mechanical oscillation system during operation detects the current and the voltage and the phase shift at the ultrasonic driver operated under operating voltage, or that only two of the parameters current, voltage and phase shift are detected.

Thus, optionally only one variable, preferably two variables or all three variables (current, voltage, phase shift) are detected. Of course, the measuring device and/or the method may be realised in such a way that the current, the voltage and/or the phase shift are not measured directly, but that at least one of the parameters is detected indirectly or by calculation.

Preferably, in all embodiments, the measuring device is set up for indirect measurement of the acousto-mechanical state via the measurement of the electromechanically coupled signal parameters of the electrical excitation in operation, in particular under electrical operating current.

The apparatus and method according to the invention may be used to carry out complex analyses with regards to the measurement fluid with relatively simple means.

In addition, these analyses or the detected parameters enable improved regulation of resonance states. This regulation may be used to automatically maintain a desired resonance state under changing fluid parameters, such as temperature changes, density changes, compressibility changes, changes in the concentration or nature of dispersed particles, droplets, or gas bubbles, etc.

In addition, an improved preparation of the measurement fluid may be carried out in all embodiments. An example of this treatment of the measurement fluid is an acoustic particle manipulation, such as particle agglomeration, particle separation, emulsion splitting or degassing (de-bubbling).

In all embodiments, the apparatus may comprise or at least partially act as a Kundt's tube.

In all embodiments, the fluid may be a liquid fluid and in particular a dispersion, especially a suspension or an emulsion. The suspension may, for example, comprise dissolved substances such as salts or undissolved particles. Particles, in the broadest sense, in the context of the invention may be, other than particles, suspended solids, pigments, crystals, biological cells, viruses or even protein micelles, droplets of immiscible liquids, oil-in-water or water-in-oil, also gas bubbles. Alternatively, the fluid may be a gaseous fluid and in particular an aerosol.

The apparatus and method according to the invention preferably enable the measurement of the electrical parameters necessary for an acoustic field characterisation under load. The electrical parameters enable, for example, the tracking of the electrical parameters for the acoustic ultrasonic field.

The invention relates in particular to a apparatus for processing and/or analysing a measurement fluid for measurement in a measuring device, comprising a fluid chamber which is filled with the measurement fluid or through which the measurement fluid flows during operation, an electrically driven ultrasonic driver which causes the measurement fluid to oscillate during operation by applying an electrical operating voltage, the measurement fluid, the ultrasonic driver, optionally a reflector and optionally further layers being parts of a resonator and of a common mechanical oscillation system during operation.

It is preferably provided that a measuring device is provided which determines the oscillation state of the mechanical oscillation system during operation by detecting current and/or voltage and/or phase shift at the ultrasonic driver operated under operating voltage.

In other words, the measuring device is designed in such a way that the oscillation state of the mechanical oscillation system is determined during operation by detecting, in particular measuring, current and/or voltage and/or phase shift at the ultrasonic driver operated under operating voltage.

Optionally, it is provided that the measuring device calculates the complex impedance or the complex admittance from the variables current, voltage and phase shift in order to determine or in determining the oscillation state of the mechanical oscillation system.

Optionally, it is provided that the measuring device detects the current and/or the voltage and/or the phase shift on the electrodes of the resonator, in particular on the electrodes of the ultrasonic driver.

Optionally, it is provided that a shunt is provided to detect the current and/or the voltage and/or the phase shift.

Optionally, it is provided that the shunt is arranged according to a first circuit configuration between an electrical signal amplification for the ultrasonic driver and an electrode of the ultrasonic driver.

Optionally, it is provided that the shunt according to a second circuit configuration is arranged between an electrode of the ultrasonic driver and a ground line.

Optionally, it is provided that the measuring device is configured for indirect measurement of the acousto-mechanical state via the measurement of the electromechanically coupled signal parameters of the electrical excitation in operation, in particular under electrical operating current. Optionally, it is provided that the ultrasonic driver comprises one or more ultrasonic driver units, and/or that the ultrasonic driver comprises one or more piezoelectric ultrasonic drivers, and/or that the ultrasonic driver is formed by one or more piezoelectric ultrasonic drivers, wherein the ultrasonic driver units may optionally be arranged at different positions along the fluid chamber. Optionally, it is provided that the operating voltage of the operating current of the ultrasonic driver is greater than 5 V_{SS}, in particular is greater than 10 V_{SS} or is greater than 30 V_{SS} and is preferably about 15 V_{SS}, wherein the voltage specifications are in each case the voltage difference between the voltage peak value and the voltage valley value of the AC voltage.

In particular, the invention relates to a measuring device comprising an apparatus according to the invention and optionally an additional sensor assembly which is set up to analyse the measurement fluid arranged or flowing in the fluid chamber and set in oscillation.

In particular, the invention relates to a method for processing and/or analysing a measurement fluid for measurement in a measuring device,
wherein the measurement fluid is arranged in a fluid chamber or flows through the fluid chamber during operation,
wherein the measurement fluid is set in oscillation by applying an operating current to an electrically driven ultrasonic driver,
wherein the measurement fluid, the ultrasonic driver and optionally a reflector are parts of a resonator and of a common mechanical oscillation system during operation.

It is preferably provided that the oscillation state of the mechanical oscillation system during operation is determined by detecting current and/or voltage and/or phase shift at the ultrasonic driver operated under operating voltage.

Optionally, it is provided that, in order to determine or in determining the oscillation state of the mechanical oscillation system, the complex impedance or the complex admittance from the variables current, voltage and phase shift is calculated.

Optionally, it is provided that the current and/or the voltage and/or the phase shift on the electrodes of the resonator, in particular on the electrodes of the ultrasonic driver, is or are detected.

Optionally, it is provided that the current and/or the voltage and/or the phase shift is or are detected according to a first circuit configuration via a shunt arranged between the output of the electrical signal amplification and an electrode of the ultrasonic driver.

Optionally, it is provided that the current and/or the voltage and/or the phase shift is or are detected according to a second circuit configuration via a shunt arranged between the output of the electrical signal amplification and an electrode of the ultrasonic driver.

Optionally, it is provided in that the acousto-mechanical state is indirectly measured via a measurement of the electromechanically coupled signal parameters of the electrical excitation in operation, in particular under operating current.

Optionally, it is intended that one or more of the following parameters are collected: Particle presence in the measurement fluid, change in particle presence in the measurement fluid, particle concentration in the measurement fluid, change in particle concentration in the measurement fluid, total mass of the particles located in the fluid chamber, change in total mass of the particles located in the fluid chamber, temperature of the measurement fluid, change in the temperature of the measurement fluid, density of the measurement fluid, change in the density of the measurement fluid, attenuation by the measurement fluid, change in the attenuation by the measurement fluid, contamination of the ultrasonic driver and/or the reflector.

Optionally, it is provided that one or more parameters for regulating a compensation of a speed of sound change in the measurement fluid are detected, wherein the speed of sound change is caused in particular by a temperature change, a density change and/or a compressibility change. Optionally, it is provided that one or more parameters for regulating a temperature compensation are detected.

Optionally, it is provided that one or more parameters are detected for determining the resonance state, in particular by determining a conductance value, an admittance value or a susceptance value, for example the conductance maximum, the admittance maximum or the susceptance zero crossing.

Optionally, it is provided that a change of the speed of sound in the measurement fluid, in particular a change of the temperature of the measurement fluid, of the density of the measurement fluid and/or of the compressibility of the measurement fluid is detected by the fact that the resonance frequency alters with the change.

Optionally, it is provided that a resonance state is set
by roughly setting the resonance frequency in a first step,
and by precisely setting this frequency in a second step by changing it until a specific conductance value, a specific admittance value, a specific susceptance value, in particular a conductance maximum, a conductance minimum, an admittance maximum, an admittance minimum, a susceptance maximum, a susceptance minimum or a susceptance zero crossing, is determined through the measurement of current, voltage and phase shift.

Optionally, it is provided that a resonance state is maintained in that the set frequency follows a change of the resonance frequency, e.g. by a temperature change, in that it is changed until a specific conductance value, a specific admittance value, a specific susceptance value, in particular a conductance maximum, a conductance minimum, an admittance maximum, an admittance minimum, a susceptance maximum, a susceptance minimum or a susceptance zero-crossing is determined through the measurement of current, voltage and phase shift.

Optionally, it is provided that a property of the resonator, such as the power dissipation in the ultrasonic driver, is adjusted to a certain value
by inferring in a first step the temperature of the ultrasonic driver from the change of the resonance frequency,
and by limiting, in a second step, the adjusted electrical power of the ultrasonic driver so that the temperature does not exceed a certain value.

Optionally, the invention relates to an apparatus, which is configured to carry out the method according to the invention.

Optionally, the method is carried out by means of the apparatus according to the invention.

Optionally, it may be provided that the presence of particles in the measurement fluid is determined in
that the measurement fluid is put into a resonance state,
that, optionally, particles present in the measurement fluid separate due to the resonance state and, in particular, agglomerate,
wherein the resonance frequency of the ultrasound changes due to the agglomeration of particles,
or/and wherein the quality of a resonance of the ultrasound is changed by the agglomeration of particles,
and/or wherein the admittance response at different frequencies changes due to the agglomeration of particles,
or/and wherein the spectrum of the driver signal is changed by the agglomeration of particles.

Optionally, it may be provided
that the measurement fluid is put into a resonance state,
that particles present in the measurement fluid separate due to the resonance state and, in particular, agglomerate,
that a change in the particle concentration, in particular the change in the total mass of the particles with a constant particle size, in the measurement fluid is determined in
that a change in the resonance frequency of the ultrasound is determined,
or/and that the quality of a resonance of the ultrasound changes,
and/or wherein the admittance response at different frequencies changes due to the agglomeration of particles,
or/and that the spectrum of the driver signal changes.

Optionally, it may be provided that the particle concentration, in particular the in the total mass of the particles with a constant particle size, in the measurement fluid is determined in
that the measurement fluid is put into a resonance state,
that particles present in the measurement fluid separate due to the resonance state and, in particular, agglomerate,
wherein the resonance frequency of the ultrasound changes by a certain amount depending on the particle concentration,
or/and wherein the quality of one or more resonances of the ultrasound changes or decreases with increasing particle concentration,
and/or wherein the admittance response changes at different frequencies due to agglomeration of particles,
or/and wherein the spectrum of the driver signal changes depending on the particle concentration.

Optionally, it may be provided that a change or determination of the attenuation by the measurement fluid, a change or determination of the contamination/coating of the ultrasonic driver and/or the reflector is thereby determined,
that the resonance frequency is changed,
or/and that the quality of one or more resonances is changed,
and/or whereby the admittance response is changed at different frequencies,
or/and that the spectrum of the driver signal is changed.

Optionally, it may be provided that the measurement fluid is degassed or freed from particles by the application of an ultrasonic field, which is facilitated or caused by the fact that the set frequency tracks a change in the resonance frequency caused by the separation.

Optionally, it may be provided that the degassing state is evaluated by observing current, voltage and/or phase.

In all embodiments, it is preferably provided that the measuring device comprises a data processing device for processing, calculating and outputting data.

The measuring device may comprise different circuit configurations. A possible first circuit configuration is the measurement of the load current via a shunt on the so-called high-side. Here, the load current is detected via a shunt between the output of the electrical signal amplification and the electrodes of the ultrasonic driver. In particular, the voltage before the shunt is measured and the voltage after the shunt is measured. By suitable analogue subtraction of the two signals, using Ohm's law, the current through the shunt and thus the current that must necessarily flow through the ultrasonic driver may be measured. Furthermore, the phase angle between the voltage before the shunt and the current through the shunt is also preferably measured.

In an alternative, second circuit configuration, a so-called low-side measurement is performed. In this case, the shunt is connected or arranged between the ultrasonic driver and the ground line in whose direction the current flow occurs. Here, the voltage is again measured at the output of the electrical signal amplification (driver). Using Ohm's law, the current through the shunt can be measured. However, the measurement is preferably carried out by a mass-referenced voltage measurement before the shunt. Again, the phase angle between voltage and current is also preferably measured.

In particular, the invention relates to a measuring device in or for the driver electronics for a resonator comprising at least one ultrasonic driver, a fluid chamber filled with a measurement fluid, and possibly a reflector. The ultrasonic driver may be an assembly comprising several ultrasonic driver units.

The measuring device is preferably configured to detect current, voltage and/or phase in the driver signal and to infer the oscillation state of the resonator, e.g. of the liquid layer, therefrom in order to use this information to attain certain states and/or to determine measured values.

Certain tasks may be undertaken for the sensor/resonator, which are supported or enabled by the electronic circuitry: for example, starting resonance frequencies and in particular resonance frequency sequences that are most suitable for the purpose, tracking the resonance in the event of temperature changes so that, for example, a particle assembly is maintained, or also regulating the energy input so that not too much heat is generated.

In particular, the invention also relates to a measuring device for analysing the measurement fluid. In this measuring device, the analysis of the measurement fluid may be carried out by the device according to the invention or at least by its measuring device. In addition or alternatively, the analysis of the measurement fluid in the measuring device may also be carried out by a separate sensor, for example by a conventional sensor for fluid analysis. Preferably, the device according to the invention is used to prepare the measurement fluid for measurement.

Preferably, the measuring device according to the present invention may be easily retrofitted to conventional measuring devices, in particular to their resonators.

The invention is now further described with reference to a preferred embodiment: The embodiment relates to an apparatus, a method and optionally also a circuit for indirect measurement of the acousto-mechanical state via the measurement of the electromechanically coupled signal parameters of the electrical excitation under load, the analysis, storage and processing of these parameters and the software which, based on this, controls whether the applied frequency or the intensity is to be changed or corrected.

### BACKGROUND OF THE PREFERRED EMBODIMENT

In oscillating systems, the acoustic/mechanical behaviour usually depends on the frequency at which the system oscillates. This is generally referred to as resonance behaviour—at certain frequencies the system oscillates more strongly. This applies both to purely mechanical systems as well as to electrically excited systems such as the Kundt's tube. The resonance behaviour of such systems depends, among other things, directly on the speed of sound of the individual components. The speed of sound depends strongly on the temperature; in fluids it is equal to the root of the quotient of the compression modulus and the density, and in ideal gases it is optionally proportional to the root of the absolute temperature. In the case of liquids, dissolved substances, for example salt concentration or similar, can also play a role. This means that changes in such parameters can produce resonance state changes.

### APPLICATION OF THE PREFERRED EMBODIMENT

One type of technical system of interest in relation to the embodiment comprises a resonator with an electrically driven source with at least two electrodes, the source being in contact with a liquid or gas layer. This may happen directly or via transfer layers. The resonator is preferably finished by a reflector, i.e. by a final layer with a considerable increase in the acoustic characteristic impedance. Such systems are preferably used for acoustic particle manipulation.

Having a certain resonance state is important for different functions of the embodiment. The energy density in the fluid layer can be decisive here, but also the power dissipation density in the driving layer, especially in the ultrasonic driver, which includes a PZT element, for example. One way to infer acousto-mechanical parameters from electrically measured parameters is to apply an analytical matrix transfer model. This offers an analytical, exact solution for purely parallel-laminated resonators and may also be used within certain limits for structures in which the material parameters do not change strictly in one direction. Thus, by detecting the complex electrical variables at a certain frequency, e.g. current, voltage and phase angle in between, different electrical and acousto-mechanical properties in the resonator can be calculated. This may be used, for example, for the cases mentioned above—energy density in the fluid layer or power dissipation density in the ultrasonic driver. However, since it is an analytical solution, the model may be applied to many conceivable situations.

Other models such as FEM or the like may also be used, e.g. to calculate a characteristic diagram, which is then stored in the measuring device or in the data processing device. Said analytical model is preferably valid for purely layered resonators, i.e. consisting of plane, parallel layers. Direct control of acoustic frequency and electrical signal level may therefore be preceded by modelling. Typically, it starts with the component(s) of the ultrasonic driver, e.g. the PZT disks of the piezoelectric units, which are measured and this simple setup is simulated in order to obtain data for the actual material parameters, as these sometimes deviate considerably from the data sheet values. The further layers may then be added step by step, both in the model as well as in reality.

At best, the model is assembled layer by layer in such iterations—extension, measurement, modelling. This ensures that the model is as close as possible to reality.

The aforementioned power dissipation density provides information about what proportion of the energy is converted into heat, i.e. it is a measure for the heating-up of the system. It may therefore be beneficial to reduce the power of the electrical driver signal to prevent a temperature increase. This applies to biological applications, but also, for example, to prevent the aforementioned change in the speed of sound.

The other aforementioned case of energy density in the liquid layer has to do intrinsically with a preferred field of application. The energy density is directly linked to the sonic radiation forces that are responsible for particle agglomeration, particle separation, de-population of certain areas, emulsion splitting and also de-bubbling. Therefore, if the conditions change, i.e. the resonance state changes due to changes in the system, then it is important to change the frequency and possibly also the power so that the resonance state is restored. If, for example, particle separation is carried out to increase the quality of a measurement, then intervention is already advantageous in order not to disturb the measurement process.

### DESCRIPTION OF A POSSIBLE FUNCTIONING OF THE PREFERRED EMBODIMENT

A method is provided for the regulation task set herein, which may detect the applied voltage, the current and the phase difference between the two at the electrodes of the electrical driver units of such a resonator under load, for example at voltages of 1000 V_{SS}.

The measurement results of voltage, current and/or phase—it may also be the complex impedance or the complex admittance—are compared with regard to the desired value in the resonator or with a model. Subsequently, the driver signal may be regulated in terms of frequency and/or intensity. The desired value may result from an analytical or numerical model that is stored or calculated “live”. It is also conceivable that another measurement, such as that of the deflection or deflection speed, is used as the basis for the regulation.

A typical design includes an ultrasonic driver with at least two electrodes. Furthermore, preferably, a liquid layer and a reflector, i.e. a final impedance stage, are assumed. This is a simple case—but there may be other areas, such as adaptation layers or even backplanes to broaden the frequency response.

The resonance state—in accordance with the invention may preferably be any oscillation state of the system—is set as described with the above-mentioned measurement and a comparison with a model. Optionally, changes in the course of the process are also compensated. These may be particle manipulation applications such as agglomeration, separation, de-population, selectivity enhancement of measurements, separation of particles, emulsion splitting, etc. For example, the mechanical resonance of the resonator, i.e. the frequency at which the maximum acoustic energy acts in the liquid layer, is used.

For example, the energy density in the fluid layer of such a layered resonator may be calculated, trying to keep the frequency within the maximum range to optimise the effectiveness of the filter. An adjustment of the frequency and/or intensity necessary due to changes in the resonator is also detected and may be evaluated as a separate measurement signal. Thus, it may be shown that particles fixed in resonators influence the admittance response. More precisely, for example, the resonance frequency and the resonance quality, measured with a benchtop network analyser, are influenced by the assembly of a group of particles—the resonance frequency shifts depending on the position of the resonance and the resonance quality decreases when particles, such as yeast cells or PMMA particles, are present in the agglomeration or separation caused by the sound field.

Further measurements have shown that such shifts, i.e. local manipulation in the liquid layer, lead to shifts in the waveform of the excitation signal. In other words, the spectrum of the resonator changes. This means that information about the particle ensemble in the liquid layer may be obtained via the change in spectrum, resonance frequency or quality, so measurements may be undertaken on the liquid.

The embodiment or a preferred apparatus enables the measurement of the electrical parameters necessary for acoustic field characterisation under load. The electrical parameters enable, inter alia, the tracking of the electrical parameters for the acoustic ultrasonic field.

The electrical parameters detected or measured by the circuit are voltage, the current flowing through the measuring resistor and the difference in phase between the voltage signal and the current signal. The circuit is characterised by the fact that signals from the low LF-range up to high into the two-digit MHz-range may be detected linearly, processed analogue and converted by the circuit into DC signal voltages that are easy to evaluate. This makes it possible to dispense with very fast analogue/digital converters (ADC) and the associated complex digital signal processing. The DC voltages output by the circuit may be captured and processed by commercially available and precise ADCs with low sampling frequencies. Of course, the signals may also be read out and processed by fast ADCs.

The current is preferably measured indirectly, using Ohm's law, via a current measuring resistor. There are also alternative approaches to measuring the current, such as measurement by means of a current transformer, a Rogowski coil, via the Hall effect or via the AMR effect or optionally via other magneto-resistive effects. The choice of effect for current measurement is made according to criteria of the maximum bandwidth in frequency required for the measurement task.

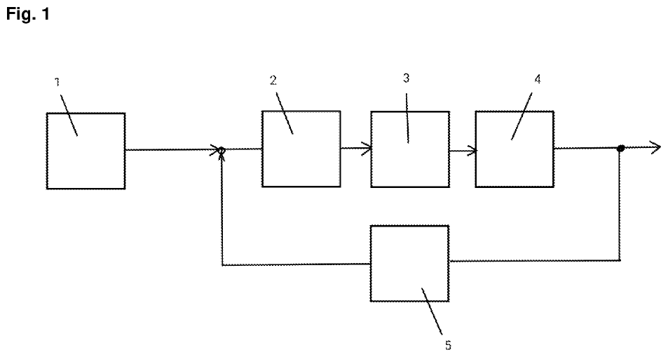

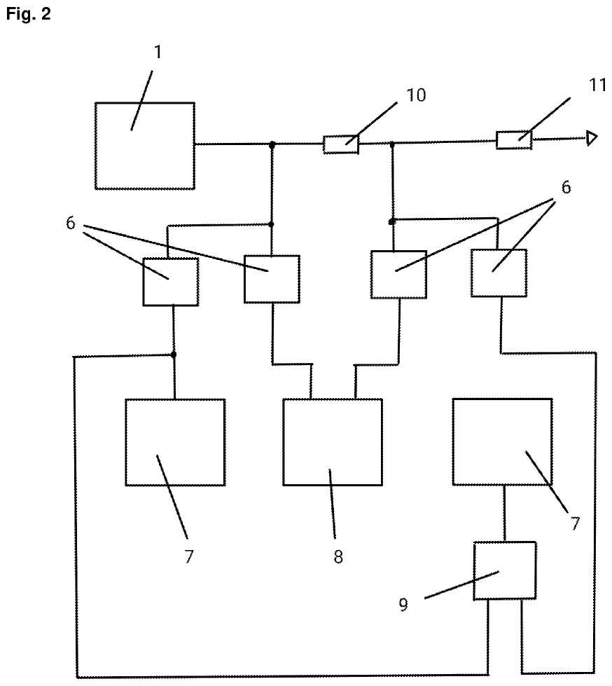

The invention will now be further described with reference to exemplary embodiments, illustrated in FIGS. 1 and 2.

FIG. 1 shows decisive components of a circuit for regulating a resonance state.

FIG. 2 shows decisive components of a circuit of a measuring device.

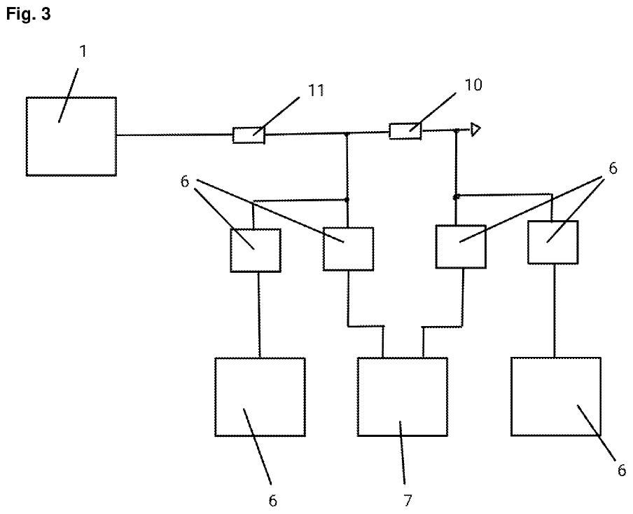

FIG. 3 shows decisive components of a circuit of a measuring device.

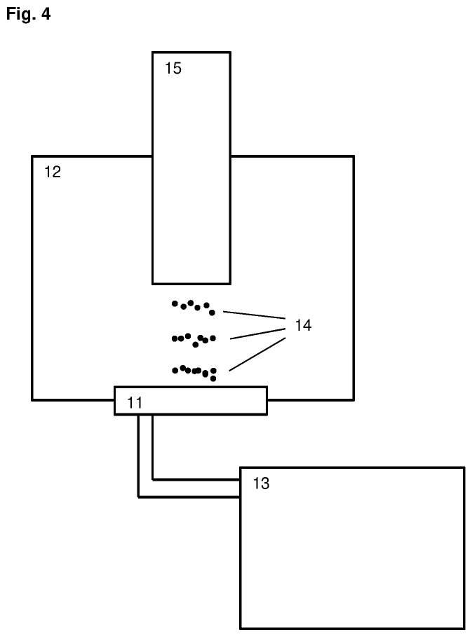

FIG. 4 shows a schematic view of components of a measuring device.

Unless otherwise indicated, the reference numbers correspond to the following properties:

Signal source 1, controller 2, control device 3, controlled system 4, measuring device 5, attenuation 6, current measurement 7, phase measurement 8, instrumentation block 9, shunt 10, ultrasonic driver 11, fluid chamber 12, amplifier 13, particle 14, sensor 15.

FIG. 1 shows an embodiment of a control circuit with a controller 2, at least one signal source 1, a control device 3, a controlled system 4 and the measuring device 5.

FIG. 2 shows a circuit in the configuration of a high-side measurement with an attenuation 6, a voltage measurement or a voltage-proportional current measurement 7, a phase measurement 8 between voltage and current and a measuring impedance and/or a shunt 10. For an arrangement of the circuit as a high-side measurement, an instrumentation block 9 is provided for current measurement 7.

For the high-side measurement, the electrical amplifier 13 for the ultrasonic driver 11 is provided at the output of the controlled system 4, the shunt 10 being connected in front of the load, in particular in front of the ultrasonic driver 11.

FIG. 3 shows a circuit in the configuration of a low-side measurement. Here, no instrumentation block 9 is required. Here, the electrical amplifier 13 for the ultrasonic driver 11 is arranged in front of the load, i.e. in front of the ultrasonic driver 11. The shunt 10 is arranged after the ultrasonic driver 11, the shunt 10 being connected to ground.

FIG. 4 shows a schematic arrangement of components of a possible embodiment of a measuring device. This comprises a fluid chamber 12 which is filled with a measurement fluid during operation. The fluid chamber 12 may be a closed chamber or an open chamber and optionally a chamber through which the measurement fluid flows.

During operation, an ultrasonic driver 11, which is preferably designed as a sound generator, such as a piezoelectric sound generator, acts on the measurement fluid located in the fluid chamber 12. The ultrasonic driver 11 is connected to an amplifier 13, wherein the amplifier 13 is designed in particular as an electrical signal amplifier for operating the ultrasonic driver 11.

During operation, the measurement fluid, the ultrasonic driver 11, a reflector and optionally other layers form parts of a resonator and a common mechanical oscillation system. The oscillation system may produce a desired resonance state. In the present embodiment of FIG. 4, a resonance state is created in which separation and agglomeration of the particles 14 occurs in several areas. According to the invention, a measuring device 5 is provided which detects the current, the voltage and the phase shift at the ultrasonic driver 11 in order to determine the oscillation state of the mechanical oscillation system during operation. In all embodiments, the measuring device 5 is preferably part of a circuit comprising the ultrasonic driver 11 and the amplifier 13. Preferably, the measuring device 5 is part of the circuit according to FIG. 2 or FIG. 3.

In addition, in this embodiment, a sensor 15 is also provided for analysing the measurement fluid. This sensor 15 or its surface may also act as a reflector, as in the present case. The sensor 15 may, for example, be an optical sensor such as an infrared sensor. In case the parameters of the measurement fluid to be determined can be detected by the measuring device 5 itself, such a sensor 15 may also be omitted.

1. An apparatus for processing and analysing a measurement fluid for measurement in a measuring device, comprising:
a fluid chamber (12), which is filled by the measurement fluid or through which the measurement fluid flows during operation,
an electrically driven ultrasonic driver (11) which causes the measurement fluid to oscillate during operation by applying an electrical operating voltage,
wherein the measurement fluid, the ultrasonic driver (11), optionally a reflector and optionally additional layers, are parts of a resonator and of a common mechanical oscillation system during operation,
characterised in that
a measuring device (5) is provided which determines the oscillation state of the mechanical oscillation system during operation by detecting current and/or voltage and/or phase shift at the ultrasonic driver (11) operated under operating voltage.

2. The apparatus according to claim 1, characterised in that the measuring device (5) calculates the complex impedance or the complex admittance from the variables current, voltage and phase shift in order to determine the oscillation state of the mechanical oscillation system.

3. The apparatus according to claim 1, characterised in that the measuring device (5) detects the current and/or the voltage and/or the phase shift on the electrodes of the resonator, in particular on the electrodes of the ultrasonic driver (11).

4. The apparatus according to claim 1, characterised in that a shunt (10) is provided for detecting the current and/or the voltage and/or the phase shift,
wherein the shunt (10) is arranged according to a first circuit configuration between an electrical signal amplification for the ultrasonic driver (11) and an electrode of the ultrasonic driver (11),
or wherein the shunt (10) is arranged according to a second circuit configuration between an electrode of the ultrasonic driver (11) and a ground line.

5. The apparatus according to claim 1, characterised in that the measuring device (5) is configured for indirect measurement of the acousto-mechanical state via the measurement of the electromechanically coupled signal parameters of the electrical excitation in operation, in particular under electrical operating current.

6. The apparatus according to claim 1, characterized
in that the ultrasonic driver (11) comprises one or more ultrasonic driver units,
and/or in that the ultrasonic driver (11) comprises one or more piezoelectric ultrasonic drivers (11),
and/or that the ultrasonic driver (11) is formed by one or more piezoelectric ultrasonic drivers (11),
wherein the ultrasonic driver units may optionally be arranged at different positions along the fluid chamber (12).

7. The apparatus according to claim 1, in that the operating voltage of the operating current of the ultrasonic driver (11) is greater than 5 V_{SS}, in particular is greater than 10 V_{SS} or is greater than 30 V_{SS} and is preferably about 15 V_{SS}, wherein the voltage specifications are in each case the voltage difference between the voltage peak value and the voltage valley value of the AC voltage.

8. A measuring device comprising an apparatus according to claim 1 and, optionally, an additional sensor arrangement which is configured to analyse the measurement fluid arranged or flowing in the fluid chamber (12) and set in oscillation.

9. A method for processing and analysing a measurement fluid for measurement in a measuring device,
wherein the measurement fluid is arranged in a fluid chamber (12) or flows through the fluid chamber (12) during operation,
wherein the measurement fluid is set in oscillation by applying an operating current to an electrically driven ultrasonic driver (11),
wherein the measurement fluid, the ultrasonic driver (11) and optionally a reflector are parts of a resonator and of a common mechanical oscillation system during operation,
characterised in that
the oscillation state of the mechanical oscillation system during operation is determined by detecting the current and/or the voltage and/or the phase shift at the ultrasonic driver (11) operated under operating voltage.

10. The method according to claim 9, characterised in that the complex impedance or the complex admittance is calculated from the variables current, voltage and phase shift in order to determine the oscillation state of the mechanical oscillation system.

11. The method according to claim 9, characterised in that the current and/or the voltage and/or the phase shift is or are detected on the electrodes of the resonator, in particular on the electrodes of the ultrasonic driver (11).

12. The method according to claim 9, characterised
in that the current and/or the voltage and/or the phase shift is or are detected according to a first circuit configuration via a shunt (10) arranged between the output of the electrical signal amplification and an electrode of the ultrasonic driver (11),
or in that the current and/or the voltage and/or the phase shift is or are detected according to a second circuit configuration via a shunt (10) arranged between the output of the electrical signal amplification and an electrode of the ultrasonic driver (11).

13. The method according to claim 9, characterised in that the acousto-mechanical state is indirectly measured via a measurement of the electromechanically coupled signal parameters of the electrical excitation in operation, in particular under operating current.

14. The method according to claim 9, characterised in that one or more of the following parameters are detected: Particle presence in the measurement fluid, change in particle presence in the measurement fluid, particle concentration in the measurement fluid, change in particle concentration in the measurement fluid, total mass of the particles (14) located in the fluid chamber (12), change in total mass of the particles (14) located in the fluid chamber (12), temperature of the measurement fluid, change in the temperature of the measurement fluid, density of the measurement fluid, change in the density of the measurement fluid, attenuation by the measurement fluid, change in the attenuation by the measurement fluid, contamination of the ultrasonic driver (11) and/or the reflector.

15. The method according to claim 9, characterised
in that one or more parameters for regulating compensation of a change in speed of sound in the measurement fluid are acquired,
wherein the change in speed of sound is caused in particular by a change in temperature, a change in density and/or a change in compressibility.

16. The method according to claim 9, characterised
in that one or more parameters for regulating a temperature compensation are detected.

17. The method according to claim 9, characterised—in that one or more parameters for determining the resonance state are detected, in particular by determining a conductance value, an admittance value or a susceptance value, for example the conductance maximum, the admittance maximum or the susceptance zero crossing.

18. The method according to claim 9, characterised in that a change in speed of sound in the measurement fluid, in particular a change in the temperature of the measurement fluid, the density of the measurement fluid and/or the compressibility of the measurement fluid is detected
in that the change alters the resonance frequency.

19. The method according to claim 9, characterised in that a resonance state is set
by roughly setting the resonance frequency in a first step,
and by precisely setting this frequency in a second step by changing it until a specific conductance value, a specific admittance value, a specific susceptance value, in particular a conductance maximum, a conductance minimum, an admittance maximum, an admittance minimum, a susceptance maximum, a susceptance minimum or a susceptance zero crossing, are determined through the measurement of current, voltage and phase shift.

20. The method according to claim 9, wherein the resonance state is maintained
in that the set frequency follows a change of the resonance frequency, e.g. by a temperature change, in that it is changed until a specific conductance value, a specific admittance value, a specific susceptance value, in particular a conductance maximum, a conductance minimum, an admittance maximum, an admittance minimum, a susceptance maximum, a susceptance minimum or a susceptance zero-crossing is determined through the measurement of current, voltage and phase shift.

21. The method according to claim 9, characterised in that a property of the resonator, such as the power dissipation in the ultrasonic driver (11), is adjusted to a certain value
by inferring in a first step the temperature of the ultrasonic driver (11) from the change of the resonance frequency,
and by limiting, in a second step, the adjusted electrical power of the ultrasonic driver (11) so that the temperature does not exceed a certain value.
